(19) United States
(12) Patent Application Publication
(10) Pub. No.: US 2023/0107846 A1
(43) Pub. Date: Apr. 6, 2023

(54) Decomposition reactor for pyrolysis of hydrocarbon feedstock

(71) Applicant: Molten Industries Inc., Oakland, CA (US)

(72) Inventors: Kevin A. Bush, Oakland, CA (US); Caleb C. Boyd, Menlo Park, CA (US)

(21) Appl. No.: 17/954,635

(22) Filed: Sep. 28, 2022

Related U.S. Application Data
(60) Provisional application No. 63/252,159, filed on Oct. 5, 2021.

(51) Int. Cl. B01J 6/00; C01B 32/312; C01B 32/205

(52) U.S. Cl. CPC B01J 6/008; C01B 32/312; C01B 32/205

(57) ABSTRACT

A multi-stage decomposition reactor and method for thermochemical decomposition (pyrolysis, cracking, direct decomposition) of a hydrocarbon feedstock of various compositions that may include mixtures. The feedstock in a supply flow passing through a heating stage is activated by raising its temperature to a decomposition temperature, dependent on the nature of the feedstock. The physical length of the heating stage and a velocity of flow once activated are tuned such that a heating residence time of the flow is shorter than an average decomposition onset time at the decomposition temperature (e.g., before 1% or more feedstock decomposition). The heating stage is followed by a decomposition stage that supports a decomposition residence time that is longer than the average decomposition onset time. A molten material can be present in the decomposition stage that can be rotated to facilitate mopping up of carbon depositions.

### CROSS-REFERENCE TO RELATED APPLICATIONS

This application claims priority from U.S. Provisional Patent Application No. 63/252,159 filed on Oct. 5, 2021 and which is incorporated herein by reference for all purposes in its entirety.

### FIELD OF THE INVENTION

The present invention relates generally to multi-stage decomposition reactors for thermochemically decomposing a hydrocarbon feedstock in a reaction accompanied by hydrogen production in a manner that separates the stages where the hydrocarbon feedstock is brought up to pyrolysis temperatures and where the hydrocarbon thermochemically decomposes.

### BACKGROUND OF THE INVENTION

The United States produces 10 million metric tons of hydrogen per year. 95% of it is produced via steam methane reforming (SMR) and it is accompanied by emission of 100 million tons of CO₂ in the process (see A. Majumdar et al., “A framework for a hydrogen economy”, Joule, Vol. 4, Issue 8, 18 Aug. 2021, pp 1905-1908). Methane pyrolysis, which thermally decomposes methane (CH₄) into H₂ and C, is potentially the most cost-effective solution to reduce emissions associated with hydrogen production, but existing approaches have proven difficult to scale (see M. Steinberg, “The direct use of natural gas for conversion of carbonaceous raw materials to fuels and chemical feedstocks”, International Journal of Hydrogen Energy, Vol. 11, Issue 11, 1986, pp. 715-720 and also S. Schneider et al., ChemBioEng Reviews, Vol. 7, 2020, pp. 1-10). Hydrogen via methane decomposition could be cheaper than that produced through water electrolysis or existing steam methane reforming with carbon capture. Scalable, cost-effective methane pyrolysis has yet to be widely commercialized as it presents a number of fundamental process design and scale-up challenges.

The thermal decomposition of hydrocarbon feedstocks as a means of generating hydrogen, carbon black, or any variety of hydrocarbons such as alkanes or aromatic hydrocarbons is an advanced process that is at the center of multiple industries, including carbon black production via methane hydrolysis and oil refining via hydrocarbon cracking. Thermal decomposition of hydrocarbons includes a wide variety of processes also known as pyrolysis, cracking, and others in which a hydrocarbon is split into smaller constituents at elevated temperatures, typically above 400° C. but even above 1,000° C. In classical chemistry, a decomposition reaction is one in which a compound breaks into two or more simpler substances, typically requiring energy input to break chemical bonds. Hydrocarbon cracking or pyrolysis can be paired with combustion but is not the same as combustion, in which a compound is combined with oxygen to produce oxides as products.

Carbon black is currently manufactured using either the furnace black process (95% of production) or the thermal black process (<5% of production). The furnace black process continuously injects heavy aromatic oil feedstock into an air stream that is heated through combustion of natural gas at 1,300° C. to 1,500° C. The feedstock pyrolyzes, creating carbon black, before it is quenched with water to reduce the temperature below 1,000° C. to stop the reaction and control the particle size. The thermal black process uses the thermal decomposition of methane, in which natural gas is injected into a pair of furnaces that alternate between pre-heating via combustion and decomposition via pyrolysis. After each furnace is heated to above the decomposition temperature via combustion, fresh natural gas at a temperature below the decomposition temperature is injected into the furnace, where the natural gas is heated to the decomposition temperature and pyrolyzes to yield primarily hydrogen and carbon black.

Hydrogen is also produced in the carbon black process, but it is either used as a fuel for heating the process or is vented to the atmosphere. Methane pyrolysis for hydrogen generation is a similar process of thermal decomposition of hydrocarbon feedstocks, with a focus on capturing and utilizing both the hydrogen and solid carbon generated in the process. Methane pyrolysis is a promising technology for production of hydrogen without carbon dioxide. Therefore, a primary aim of the technology is to use renewable electric heating as a means of powering the thermal decomposition process.

Thermal decomposition of a hydrocarbon feedstock such as methane can be performed with or without the presence of an active catalyst. In the absence of a catalyst, temperatures for thermal decomposition of methane into hydrogen and solid carbon are typically above 1,000° C. Catalytic materials can reduce the temperature of thermal decomposition to as low as 400° C. or even lower. Catalytic materials for the decomposition of hydrocarbons include but are not limited to Group VIb and VIII elements of the periodic table such as iron, nickel, cobalt, noble metals, chromium, molybdenum, alloys of these metals, and even salts and oxides containing these metals.

With or without catalysts, scalable, cost-effective methane pyrolysis has yet to be widely commercialized as it presents a number of fundamental process design and scale-up challenges. It requires high temperatures which constrain the choice of materials of construction and require efficient heat transfer at high throughputs. It generates both gaseous hydrogen and solid carbon, which must be physically separated. Deposition of solid carbon in the reactor or coking is a major operational problem for any hydrocarbon feedstock thermal decomposition. It requires frequent reactor cleaning, resulting in downtime and non-continuous processes. Catalysts are deactivated by solid carbon deposition and must be replaced or cleaned. Catalytic metals and salts can contaminate the solid carbon byproduct such that it cannot be used in all applications. In fact, in some cases the extent of contamination is so high that it must even be disposed of as toxic waste.

Typical approaches for hydrocarbon decomposition include moving bed and fluidized bed reactors, plasma reactors, microwave reactors, molten metal baths and fluid wall reactors. Many pre-heat a feedstock but none superheat the feedstock to decomposition temperature in a separate stage from the actual decomposition itself. On the other hand, U.S. Pat. No. 2,749,709 to Kirkbride teaches heating the feedstock to decomposition temperature in a molten metal bath followed by decomposing in a fluidized bed. There are clear disadvantages to the process outlined in U.S. Pat. No. 2,749,709, including controlling temperature uniformity of feedstock passed through the molten bath, maintaining enough feedstock throughput to keep carbon particles fluidized, and separating carbon from the molten metal.

### OBJECTS AND ADVANTAGES

The present invention addresses a novel decomposition reactor that overcomes many of the challenges described in the prior art, including U.S. Pat. No. 2,749,709. Specifically, in light of the shortcomings in the prior art, it is an object of the invention to provide for:

1. Improved thermal efficiency of heating of hydrocarbon feedstock to its decomposition temperature;
2. Improved uniformity of heating of hydrocarbon feedstock to its decomposition temperature, resulting in a narrower distribution of product properties such as solid carbon particle morphology;
3. Reduced coking of the reactor, requiring less cleaning of the reactor and therefore increased uptime and, in some cases, a truly continuous process for the lifetime of the reactor;
4. Improved purity and uniformity of products created by the thermal decomposition of a hydrocarbon feedstock;
5. Improved throughput and space velocity of reactors for hydrocarbon feedstock decomposition.

It is apparent that the features of the invention are especially advantageous for thermal decomposition of methane for hydrogen and solid carbon production, but they also apply to the thermal or catalytic decomposition of any hydrocarbon feedstock for the product of solid carbon, hydrogen, or other carbons.

### SUMMARY OF THE INVENTION

The objects and advantages of the invention are provided for by multi-stage decomposition reactors and stage-wise methods for performing thermochemical decomposition of a hydrocarbon feedstock. Such thermochemical decomposition is also referred to as pyrolysis, cracking or direct decomposition and it is often applied to hydrocarbons such as methane or natural gas. The decomposition is thermal because it requires high temperatures to proceed. It is also typically accompanied by the production of hydrogen. Any hydrocarbon feedstock can be used including gases, liquids, or solids containing one or more hydrocarbons such as methane, butane, propane, ethane, ethylene, acetylene, propylene, natural gas, liquified petroleum gas, naphtha, shale oil, wood, biomass, organic waste streams, biogas, gasoline, kerosene, diesel fuel, residual oil, crude oil, carbon black oil, coal tar, crude coal tar, benzene, methyl naphthalene, polycyclic aromatic hydrocarbons and other such hydrocarbons. Mixtures of any of the above feedstocks with other hydrocarbon feedstocks can be used, as well as mixtures containing any of these feedstocks with other feedstocks such as mixtures of methane and nitrogen, methane and carbon dioxide, or methane and carbon monoxide. A preferred embodiment uses natural gas or a hydrocarbon feedstock primarily composed of methane as the feedstock.

An exemplary multi-stage decomposition reactor has a means or apparatus for delivering a supply flow of the hydrocarbon feedstock to the multi-stage decomposition reactor. In some embodiments, the heating stage receives and heats the supply flow to a decomposition temperature thus yielding an activated flow of the hydrocarbon feedstock. Note that the decomposition temperature is typically above 1,000° C. for methane or natural gas when there is no catalyst present. Typically, when there is a catalyst present, the decomposition temperature is above 400° C. for methane or natural gas. The hydrocarbon feedstock decomposition temperature is thus dependent on the hydrocarbon feedstock that is used as well as the catalytic or non-catalytic materials used in the reactor. Catalytic materials include Group VIb and VIII elements of the periodic table such as iron, nickel, cobalt, noble metals, chromium, molybdenum, alloys of these metals and even salts and oxides containing these metals and still other suitable catalytic materials.

In these embodiments a physical length, herein simply referred to as the length of the heating stage, and a velocity of the activated flow within the heating stage are tuned in a particular manner. Specifically, they are selected or tuned such that a heating residence time of the flow once it has become activated inside the heating stage is shorter than an average decomposition onset time of the hydrocarbon feedstock at the decomposition temperature attained, e.g., before 1% or more of the hydrocarbon stock has decomposed. This means that although the hydrocarbon feedstock has reached a decomposition temperature at which it undergoes pyrolysis it will leave the heating stage before any significant fraction, e.g., 1%, of it has undergone decomposition.

The heating stage is followed by a decomposition stage. In the decomposition stage the activated flow is decelerated. Furthermore, the decomposition stage supports a decomposition residence time that is longer than the average decomposition onset time at the specific decomposition temperature dictated by the hydrocarbon feedstock and any catalyst present. This allows for achieving substantial progression toward completion of the thermochemical decomposition of the hydrocarbon feedstock. In some embodiments the decomposition stage has a radiative heating apparatus or mechanism for maintaining the hydrocarbon feedstock at a temperature sufficient to reach substantial progression of the thermochemical decomposition during the decomposition residence time. This is especially important when the hydrocarbon feedstock is methane or natural gas, where decomposition is an endothermic process.

In some embodiments, a separation stage follows the decomposition stage. In the case of using methane or natural gas as the hydrocarbon feedstock the separation stage is designed for separating a carbon product and also for capturing hydrogen that is obtained from the hydrogen production that accompanies the thermal decomposition. In an embodiment where the hydrocarbon feedstock is composed of methane (CH₄) the carbon product is solid carbon. The carbon product may contain but is not limited to one or more of carbon black, carbon fibers, graphene, diamond, glassy carbon, high-purity graphite, carbon nanotubes, coke, activated carbon or other carbon phases or mixtures of these.

In preferred embodiments of the invention the decomposition stage has a cavity, preferably in the form of a wide cross-section tube. The wide cross-section tube typically extends along a horizontal direction and contains a molten material, e.g., a molten metal. The decomposition stage also has a means or apparatus, e.g., suitable drive and coupling mechanism, for rotating the wide cross-section tube at a certain rotation speed. This rotary action is designed to minimize carbon build-up and also to clean the decomposition stage by allowing the molten material to mop up the carbon deposited on a wall, i.e., the inner wall of the wide cross-section tube.

The rotation speed of the wide cross-section tube can be varied. Specifically, the rotation speed can be within one of two regimes: a first regime at higher rotation speeds or a second regime at lower rotation speeds. When spinning or rotating in the first regime at a higher rotation speed the molten material coats at least a substantial portion or the entire exposed surface of the inner wall of the wide cross-section tube. When spinning or rotating in the second regime at a lower rotation speed the molten material collects or accumulates at the bottom of the inner wall of the wide cross-section tube.

Alternatively, the wide cross-section tube has a porous or perforated wall through which a hot and inert supplemental gas, e.g., nitrogen (N₂), argon (Ar), or hydrogen (H₂), flows to create a barrier layer. This barrier layer of hot and inert supplemental gas prevents contact between the thermally decomposing hydrocarbon feedstock and the wide cross-section tube.

In the preferred embodiments of the invention the heating stage has a cavity in the form of a narrow cross-section tube. Such a narrow cross-section allows for better tuning of the desired heating residence time of the activated flow. For example, the narrow cross-section tube enables the heating stage to maintain the velocity at above 100 meters/second and higher. Furthermore, in order to achieve efficient heating the narrow cross-section tube of the heating stage has an electrical means or apparatus for performing the heating. Suitable electrical apparatus include inductive heating apparatus, resistive heating apparatus, or a microwave heating apparatus.

In some embodiments the multi-stage decomposition reactor also has a pre-heating stage. The pre-heating stage is located before the heating stage and is designed for pre-heating the supply flow of hydrocarbon feedstock to yield a substantially uniformly pre-heated flow. The pre-heating temperature may be in the range of a few hundred degrees, e.g., up to 400° C. Thus, the pre-heating temperature remains below the decomposition temperature, which is typically above 1,000° C., as previously noted. Note, however, that thermal decomposition of methane will be very slow below 1,000° C., but in the presence of a catalyst the decomposition temperature can drop to a much lower temperature. For example, iron (Fe) acts as a catalyst for methane decomposition at temperatures above 400° C.

In some embodiments of the multi-stage decomposition reactor the heating stage does not bring the temperature up to the decomposition temperature. Instead, the heating stage is designed for heating the supply flow to yield a heated flow of hydrocarbon feedstock at below the decomposition temperature, or below 1,000° C. for non-catalyzed decomposition. In those embodiments it is the decomposition stage that heats the supply flow received from the heating stage to the decomposition temperature to yield the activated flow of the hydrocarbon feedstock. The activated flow is also decelerated in the decomposition stage. Further, the decomposition stage ensures that the decomposition residence time spent by the activated flow within it is longer than the average decomposition onset time in order to achieve substantial progression or high yield of the thermochemical decomposition.

It is preferred that in these embodiments that the decomposition stage have the wide cross-section tube containing the molten material and that it also have the apparatus for rotating the wide cross-section tube. Again, the tube is rotated at a certain rotation speed to minimize carbon build-up and to clean the decomposition stage. The rotation speed can be in a first regime or in a second regime. Further, the inner wall can also be provided with a barrier layer of a hot and inert gas in these embodiments.

The stage-wise methods for thermochemical decomposition of the hydrocarbon feedstock accompanied by hydrogen production involve several steps. One step involves delivering the supply flow of the hydrocarbon feedstock to the heating stage. Another step carried out in the heating stage is to heat the supply flow to the decomposition temperature to yield the activated flow of hydrocarbon feedstock. In some embodiments of the method the heating stage actually only heats the supply flow to a temperature below the decomposition temperature. In those embodiments the decomposition temperature is reached in a subsequent step inside the decomposition stage.

In embodiments where the heating stage brings the temperature of the hydrocarbon feedstock up to the decomposition temperature, a tuning step is performed in the heating stage. The tuning involves choosing a length of the heating stage and a velocity of the activated flow such that a heating residence time of the activated flow in the heating stage is significantly shorter than the average decomposition onset time of the hydrocarbon feedstock at the decomposition temperature. Thus, minimal decomposition occurs in the heating stage despite the hydrocarbon feedstock being at the decomposition temperature.

Deceleration occurs in the decomposition stage. Also, the decomposition stage supports the activated flow for the decomposition residence time that is longer than the average decomposition onset time.

In a preferred and optional last step, the carbon product is separated and the hydrogen from the hydrocarbon decomposition is captured. The methods are preferably practiced in conjunction with providing the decomposition stage with the wide cross-section tube and rotating it at the selected rotation speed to minimize carbon build-up and to clean the decomposition stage.

The present invention, including the preferred embodiment, will now be described in detail in the below detailed description with reference to the attached drawing figures.

### BRIEF DESCRIPTION OF THE DRAWING FIGURES

FIG. 1A is a three-dimensional diagram of a multi-stage decomposition reactor according to the invention.

FIG. 1B is a cross-sectional side view diagram of the heating and decomposition stages of the multi-stage decomposition reactor of FIG. 1A with a temperature profile.

FIG. 1C is a cross-sectional side view diagram of the heating and decomposition stages of the multi-stage decomposition reactor of FIG. 1A with a velocity profile.

FIG. 1D is a perspective view illustrating the inside the heating and decomposition stages of the reactor of FIG. 1A.

FIG. 2 is a three-dimensional diagram illustrating the main steps involved in operating the multi-stage decomposition reactor of FIG. 1A.

FIG. 3 is a cross-sectional side view diagram of the heating and decomposition stages of a multi-stage decomposition reactor exhibiting a different tuning along with a velocity profile and a temperature profile.

FIG. 4 is a cross-sectional axial view diagram illustrating the first high rotation speed regime of the decomposition stage of the reactor of FIG. 1A.

FIG. 5A is a cross-sectional axial view diagram illustrating an embodiment with a number of narrow cross-section tubes in the heating stage flowing into a decomposition stage of the reactor of FIG. 1A.

FIG. 5B is a cross-sectional axial view diagram illustrating an embodiment in which narrow cross-section tubes of the heating stage are polygonal rather than circular for deployment in a reactor that can be analogous to the reactor of FIG. 1A.

FIG. 6 is a three-dimensional diagram illustrating a shell and tube heat exchanger for heating a multi-stage decomposition reactor that can be analogous to the reactor of FIG. 1A.

FIG. 7 are photographs of two types of carbon black produced in a multi-stage decomposition reactor of the invention.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

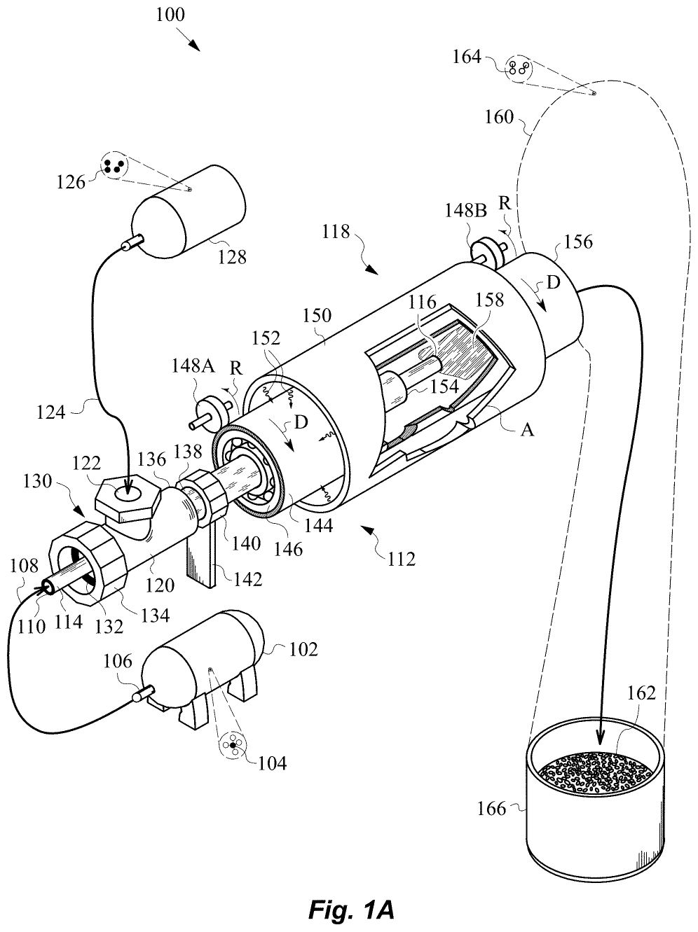

FIG. 1A is a three-dimensional diagram illustrating a multi-stage decomposition reactor 100 according to an embodiment of the invention. For reasons of clarity, FIG. 1A focuses on the main parts of reactor 100 and its overall layout or design. The overall design of reactor 100 is presented first in order to better contextualize and appreciate the specific aspects of the present invention.

Reactor 100 has a supply 102 containing a hydrocarbon feedstock 104. In the present example hydrocarbon feedstock 104 is methane (CH₄). In fact, any hydrocarbon feedstock that undergoes thermochemical decomposition also referred to as pyrolysis, cracking or direct decomposition in a manner similar to methane or natural gas are suitable. Any hydrocarbon feedstock can be used including gases, liquids, or solids containing one or more hydrocarbons such as methane, butane, propane, ethane, ethylene, acetylene, propylene, natural gas, liquified petroleum gas, naphtha, shale oil, wood, biomass, organic waste streams, biogas, gasoline, kerosene, diesel fuel, residual oil, crude oil, carbon black oil, coal tar, crude coal tar, benzene, methyl naphthalene, polycyclic aromatic hydrocarbons and other such hydrocarbons. Mixtures of any of the above feedstocks with other hydrocarbon feedstocks can be used, as well as mixtures containing any of these feedstocks with other feedstocks such as mixtures of methane and nitrogen, methane and carbon dioxide, or methane and carbon monoxide. A preferred embodiment uses natural gas or a hydrocarbon feedstock primarily composed of methane as the feedstock.

It also may be preferable to include seeding carbon materials such as carbon black, activated carbon, activated charcoal, C60, C70, carbon nanotubes, graphite flakes and other carbon materials to reactor 100 in hydrocarbon feedstock 104. Such seeding materials act to seed nucleation and growth of carbon from hydrocarbon decomposition onto the carbon seed material.

Further, it should be noted that typical reactors for cracking of hydrocarbon feedstocks may include purifying systems, separation systems, or gasification systems before the thermal decomposition stage to purify the hydrocarbon feedstock for decomposition and after the thermal decomposition reactor to separate out and purify products of thermal decomposition. A typical example for a pre-treatment is desulfurization of natural gas. A typical example for a separation of products is a bag filter system for separation of solid carbon from hydrogen in methane pyrolysis. There may also be included systems to recycle unreacted feedstock and recycle heat from the outlet products to the inlet feedstock. Many such systems are well-known to a person skilled in the art and such auxiliary systems can be used with reactor 100. Furthermore, hydrocarbon feedstock 104 as used herein includes hydrocarbons that may have already been purified, separated, mixed, or otherwise acted upon by auxiliary systems.

Reactor 100 has a delivery mechanism or apparatus 106 for delivering a smooth or substantially uniform flow referred to herein as a supply flow 108 of hydrocarbon feedstock 104 to reactor 100. More precisely, supply flow 108 is delivered to an inlet 110 of a heating stage 112 belonging to reactor 100. In the present embodiment heating stage 112 has a narrow cross-section tube 114 and supply flow 108 is injected into narrow cross-section tube 114 through inlet 110 of tube 114. Due to the thermal load that will be placed on tube 114 it is made of a very stable and thermally conductive material such as alumina, mullite, graphite, or silicon carbide.

Narrow cross-section tube 114 extends horizontally along the entire length of heating stage 112. Heating stage 112 terminates at an outlet 116 inside a decomposition stage 118 that extends horizontally and coaxially past outlet 116. This is seen through a cut-away portion A in heating stage 112 provided for better visualization.

It is desirable for heating stage 112 in the superheating section as well as decomposition stage 118 where hydrocarbon feedstock 104 achieves the highest temperatures to be made of non-catalytic materials such as alumina, mullite, silicon, carbide, graphite, sapphire, tungsten, tantalum, silica, zirconia and others that can withstand temperatures above the decomposition temperature of hydrocarbon feedstock 104. These non-catalytic materials should not cause catalytic decomposition on the surfaces of heating stage 112 or decomposition stage 118. Specifically, catalytic materials in contact with hydrocarbon feedstock 104 anywhere in reactor 100 should be kept at much lower temperatures than the thermal decomposition temperature. For methane feedstock and materials containing Fe, Ni, or Co they should be kept below a maximum temperature of 400° C. Catalytic materials include Group VIb and VIII elements of the periodic table such as iron, nickel, cobalt, noble metals, chromium, molybdenum, alloys of these metals and even salts and oxides containing these metals and others.

A tee fitting 120 is provided at the entry to reactor 100. Tee 120 has a supplemental gas intake 122 for admitting a flow 124 of a supplemental gas 126 into reactor 100. In the present embodiment, supplemental gas 126 is nitrogen (N₂) and it is supplied from a reservoir 128. Even more preferable choices for supplemental gas 126 include argon (Ar) or hydrogen gas (H₂) to avoid the formation of hydrogen cyanide in decomposition stage 118. The purpose of supplemental gas 126 is to use its flow 124 to push hydrocarbon feedstock 104 through decomposition stage 118 and substantially prevent it from flowing back into upstream portions of reactor 100 and depositing carbon onto the entry sections of reactor 100. More precisely, it is not desirable to allow hydrocarbon feedstock 104 to flow back up reactor 100 as these upstream sections may not have molten material or supplemental gas wall components described in conjunction with decomposition stage 118 below to minimize carbon deposition. Also, carbon deposition upstream could damage various mechanisms including the rotation mechanism described below.

Tee 120 also has an intake 130 for admitting narrow cross-section tube 114. A seal 132 around tube 114 is provided at intake 130 in order to ensure that flow 124 of supplemental gas 126 is contained within tee 120 and properly forwarded into reactor 100. Specifically, in the present case seal 132 is a gasket (e.g., an o-ring gasket) secured by a corresponding fitting 134.

Tee 120 offers an outlet 136 leading further into reactor 100. Outlet 136 encloses a sealed barrier tube 138 that carries supplemental gas 126 further into reactor 100. Due to the mechanical and thermal loads on barrier tube 138 it should be made of materials that are well suited to these conditions such as stainless steel or inconel. Tee 120 is described to represent merely one possible mechanism for guiding supply flow 108 of hydrocarbon feedstock 104 and flow 124 of supplemental gas 126 in reactor 100. In alternative embodiments, some of which will be more preferable depending on the overall design of reactor 100, supplemental gas 126 can be supplied through a diffuser made of a porous material such as carbon, silicon carbide or another ceramic to generate a more uniform profile of flow 124.

In the present embodiment, barrier tube 138 encloses narrow cross-section tube 114 and is indeed coaxial with tube 114. A mechanical clamp 140 along with mechanical support structure 142 stabilize barrier tube 138 before heating stage 112. Clamp 140 and support structure 142 should provide a sufficiently firm mount to allow for rotation of subsequent decomposition stage 118, as described in more detail below.

Heating stage 112 has a wide cross-section tube 144 extending coaxially with and enclosing barrier tube 138 that, again, encloses narrow cross-section tube 114. The mechanical and thermal requirements placed on tube 144 are high and it should thus be made of a suitable material such as quartz, alumina, mullite, graphite, or silicon carbide. In the present embodiment, wide cross-section tube 144 is mounted to permit it to rotate about its center axis. That axis happens to coincide with the axes of barrier tube 138 and narrow cross-section tube 114 within barrier tube 138. Specifically, a bearing 146 mounted on barrier tube 138 and engaged against the inner wall of wide cross-section tube 144 is provided to support rotation of tube 144. It should be noted that additional bearings can be provided for achieving mechanically stable rotation of tube 144. However, any additional bearings have to be mounted at locations where the temperatures do not exceed their limits and/or they should be made of thermally stable materials.

In the present embodiment two rotation drives 148A and 148B are provided for imparting rotation to tube 144. Drives 148A, 148B sit against the outer wall of tube 144. For better engagement corresponding gearing can be provided on drives 148A, 148B and on outer wall of tube 144 (not shown in FIG. 1A). Although the sense of rotation is a matter of design choice, in the present example drives 148A, 148B rotate counter-clockwise as indicated by arrows R. Thus, during operation wide cross-section tube 144 rotates clockwise, as indicated by arrows D.

Reactor 100 has a heater 150 enclosing heating stage 112 and decomposition stage 118. In the present embodiment heater 150 is an electrical heater that provides heating predominantly through irradiation. In other words, electric heater 150 is a radiative heater. Suitable electrical heaters include resistive, inductive and microwave heaters. When turned on, heater 150 radiates inwards into heating stage 112 and decomposition stage 118 from its inner surface. FIG. 1A illustrates the emission schematically by radiation 152.

As seen through cut-away portion A, barrier tube 138 terminates before the end of heating stage 112. Specifically, an outlet 154 of barrier tube 138 is located significantly upstream of outlet 116 of narrow cross-section tube 114, typically prior to entering heating stage 112. Thus, outlet 154 is configured to release supplemental gas 126 flowing through barrier tube 138 inside wide cross-section tube 144 before hydrocarbon feedstock 104 exits outlet 116.

Decomposition stage 118 starts at outlet 116 of narrow cross-section tube 114 and ends at an outlet 156 of wide cross-section tube 144. Within decomposition stage 118 wide cross-section tube 144 contains a molten material 158 such as a molten metal or molten salt. The disposition and movement of molten material 158 in decomposition stage 118 are influenced by gravity as well as rotation D of tube 144.

A separation stage 160 follows decomposition stage 118. Separation stage 160 is partly indicated in a dashed line in FIG. 1A for clarity. It should be noted that well-known stages such as a cooling stage, a quench stage and/or a heat transfer stage could also be present between outlet 156 and separation stage 160, or even after separation stage 160. These stages are not shown here for reasons of clarity and in order to focus on the main aspects of the invention.

Separation stage 160 is designed for separating a carbon product 162 and also for capturing hydrogen 164 that is obtained from the hydrogen production process that accompanies the thermal decomposition of hydrocarbon feedstock 104. In the present example hydrocarbon feedstock 104 is composed of methane (CH₄) and carbon product 162 is solid carbon that is accumulated in vessel 166.

Several important aspects of the design of multi-stage reactor 100 are shown in the cross-sectional side view diagram of heating stage 112 and decomposition stage 118 afforded by FIG. 1B. In FIG. 1B the end of heating stage 112 is demarcated from the start of decomposition stage 118 with dashed line C. Supply flow 108 of hydrocarbon feedstock 104 is shown exiting narrow cross-section tube 114 through outlet 116 into decomposition stage 118. Meanwhile, flow 124 of supplementary gas 126 is shown exiting barrier tube 138 still in heating stage 112 through outlet 154.

FIG. 1B shows a temperature profile 170 of hydrocarbon feedstock 104 travelling through a key portion of reactor 100 (see FIG. 1A). For better visualization, temperature profile 170 is drawn along or coextensively with the length of heating and decomposition stages 112, 118. Thus, it is easier to see where hydrocarbon feedstock 104 moving in uniform flow 108 along the length of reactor 100 attains the temperatures indicated in temperature profile 170.

In the present embodiment of the invention radiation 152 from electric heater 150 (see FIG. 1A) is sufficient to heat hydrocarbon feedstock 104 to reach a decomposition temperature T_{d} while still within narrow cross-section tube 114. More precisely, the heat is transferred via the outer wall of narrow cross-section tube 114 and to hydrocarbon feedstock 104 via conduction. The rate of heat transfer from the wall of tube 114 to hydrocarbon feedstock 104 is accelerated via convective heat transfer aided by turbulence present in supply flow 108.

Once at decomposition temperature T_{d} hydrocarbon feedstock 104 is considered activated. In other words, at or above decomposition temperature T_{d} pyrolysis or thermochemical breakdown of hydrocarbon feedstock 104 can proceed. Thus, supply flow 108 becomes an activated flow 108′ of hydrocarbon feedstock 104 (where the prime notation indicates the activated flow). In addition, the portion of temperature profile 170 in which supply flow 108 is heated sufficiently to yield activated flow 108′ is expressly labeled. Note that the decomposition temperature is typically above 1,000° C., and sometimes even above 1,200° C. At such temperatures an average decomposition onset time t_{dec} for methane, defined as the time before which 1% or more of the methane has decomposed, is on the order of thousandths of a second to a few seconds. Moving to still higher temperatures will reduce average decomposition onset time t_{dec} to even below a thousandth of a second at 1,600° C. Information about thermochemical decomposition parameters of hydrocarbons suitable for use in present apparatus and methods is available in the literature; see e.g., M. Wullenkord, “Determination of Kinetic Parameters of the Thermal Dissociation of Methane”, PhD Dissertation, Lehrstuhl fur Solartechnik (DLR), 2012, https://publications.rwth-aachen.de/search?p=id:%223885%22 and S. Rodat et al., “Kinetic modelling of methane decomposition in a tubular solar reactor”, Chemical Engineering Journal, 146 (2009), pp. 120-127.

FIG. 1C shows a desired velocity profile 172 of hydrocarbon feedstock 104 travelling through a key portion of reactor 100 (see FIG. 1A). As in the case of temperature profile 170, velocity profile 172 is also drawn along or coextensively with the length of heating and decomposition stages 112, 118. Thus, it is easier to see the velocity v at which supply flow 108 of hydrocarbon feedstock 104 is moving as it passes along the length of reactor 100.

In the present embodiment of the invention narrow cross-section tube 114 permits supply flow 108 to reach velocities above 100 meters/second (v>100 m/s). Such velocities are considered to be in the range of high velocity as indicated in FIG. 1C. In contrast, low velocity range is below 100 meters/second (v<100 m/s), and preferably significantly below 100 meters/second (v<<100 m/s) such as 10 meters/second or less, as also indicated in FIG. 1C. In fact, achieving uniform and rapid supply flow 108 at high velocity v of above 100 m/s and even up to 1,100 m/s as well as efficient heating of hydrocarbon feedstock 104 inside narrow cross-section tube 114 are important for the invention. Such high velocity range and low velocity range are not absolutes, but change with respect to temperature. Higher decomposition temperatures require higher velocities, while lower decomposition temperatures require lower velocities. Therefore, the velocity ranges can be tuned considerably based on the desired decomposition temperature. For example, at a decomposition temperature of 1,000° C. a high velocity range can be 0.1 m/s or more and a low velocity range can be 0.01 m/s or less, while at a decomposition temperature of 1,300° C. a high velocity range can be 100 m/s or more and a low velocity range can be 10 m/s or less.

To achieve these objectives concurrently, narrow cross-section tube 114 is chosen to have a small inner diameter or cross-section, e.g., in the range of 1-30 mm. In this cross-section range high velocity v as well as efficient heat transfer are achievable. Note that still higher velocities are less desirable, as a velocity v of ≈1,050 m/s at a temperature of 1,200° C. is at Mach 1. Supporting higher velocities is impossible without a converging/diverging nozzle, although, if necessary, such nozzle could be accommodated in tube 114. Meanwhile, the transfer of heat generated by electric heater 150 (see FIG. 1A) to hydrocarbon feedstock 104 in 1-30 mm diameter tube 114 will typically occur rapidly by conductive heat transfer from the tube wall and then by convective heat transfer within hydrocarbon feedstock 104, accelerated by turbulence.

Under the conditions shown in FIGS. 1B-C the physical length of narrow cross-section tube 114 (in the present example the length of heating stage 112), the inner diameter of tube 114, the amount of heat 152 delivered as well as high velocity v of supply flow 108 exhibit a desirable joint effect. Namely, this tuning ensures that once uniform supply flow 108 becomes activated flow 108′ due to heating of hydrocarbon feedstock 104, as seen in FIG. 1B and expressly indicated on temperature profile 170 by a hatched section, it does not remain in tube 114 for long. The high velocity v of supply flow 108 guarantees a short residence time or heating residence time tₕᵣ of active flow 108′ (expressly labeled by “short heat res. time” in FIG. 1C and indicated by hatching on velocity profile 172) in heating stage 112 or within tube 114. Thus, the tuning ensures that only very limited pyrolysis or thermochemical decomposition of hydrocarbon feedstock 104 takes place inside tube 114. More specifically, the above parameters are selected or tuned such that heating residence time tₕᵣ of active flow 108′ inside heating stage 112 is significantly shorter, e.g., 10 times shorter or still less, than an average decomposition onset time t_{dec} of hydrocarbon feedstock 104 at decomposition temperature T_{d} attained within tube 114. Residence times in the superheating portion of heating stage 112 for methane or natural gas are preferentially, but not strictly limited to, 0.000001 to 1 second. Again, this means that although hydrocarbon feedstock 104 has reached decomposition temperature T_{d} at which it undergoes pyrolysis, it will exit heating stage 112 through outlet 116 before any significant fraction, e.g., 1% of it has undergone decomposition. This also means that only limited deposition of carbon on the heating surface or coking will occur inside tube 114. These conditions are favorable for suppressing decomposition and allowing for high throughput of hydrocarbon feedstock 104 at low energy cost.

Heating stage 112 is followed by decomposition stage 118 where hydrocarbon feedstock 104 is still travelling in activated flow 108′ above decomposition temperature T_{d}. Again, this is clearly seen in FIG. 1B where activated flow 108′ is expressly labeled on temperature profile 170. Hydrocarbon feedstock 104 clearly remains activated and thus subject to pyrolysis for an appreciable length or distance within decomposition stage 118.

Importantly, however, inside decomposition stage 118 activated flow 108′ is decelerated, as evident from velocity profile 172 in FIG. 1C. For example, in under 1 meter activated flow 108′ decelerates and its velocity v enters into low velocity range indicated below 100 m/s. From there velocity v continues to drop rapidly into a range of just a few meters/second. Due to this deceleration the amount of time activated flow 108′ will spend in decomposition stage 118 while its temperature is still above decomposition temperature T_{d} is long. Specifically, this time or period, referred to herein as decomposition residence time t_{dr} is long relative to the required time for hydrocarbon in activated flow 108′ to substantially decompose, i.e., to achieve >90% decomposition. Decomposition residence time t_{dr} is roughly 0.1 s at 1,500° C. or 10 s at 1,200° C. or even longer. Decomposition residence time t_{dr} is expressly labeled in FIG. 1C with reference to velocity profile 172. Note that residence times in decomposition stage 118 for methane and natural gas are preferably, but not strictly, limited to 0.0001 to 100 seconds.

In fact, a cross-hatched region of velocity profile 172 indicates where these advantageous conditions exist for achieving substantial progression of the thermochemical decomposition of hydrocarbon feedstock 104 within decomposition stage 118. Differently put, decomposition stage 118 supports decomposition residence time t_{dr} that is longer than average decomposition onset time t_{dec}, i.e., t_{dr}>t_{dec}) This allows for achieving substantial progression of the thermochemical decomposition of the hydrocarbon feedstock and production of hydrogen.

Now, decomposition stage 118 can be configured to achieve rapid deceleration of activated flow 108′ in a number of ways. Most conveniently, deceleration is obtained when the volume of decomposition stage 118 is chosen to be much larger than that of heating stage 112. In the present embodiment deceleration of activated flow 108′ is achieved by the wide cross-section tube 144 of decomposition stage 118 having a much larger inner diameter than the inner diameter of narrow cross-section tube 114. For example, inner diameter of wide cross-section tube 144 is more than 100 times (100×) the inner diameter of narrow cross-section tube 114. Given that in the present example embodiment the inner diameter of tube 114 is between 1 and 30 mm, an appropriate inner diameter of tube 144 is at least between 10 and 300 cm. Volumetric flow rate Q is equal to flow velocity v times the cross-sectional area A_{c}. In the case of tubes the cross-sectional area A_{c} is related to the radius squared by π, in other words: Q=A_{c}×v=πr²v. Solving this equation for velocity v yields:

$$v = \frac{Q}{π {r}^{2}} .$$

Thus, when the diameter of the tube increases from 2 mm to 20 mm, the flow velocity decreases approximately by 100 times (100×). It should be noted that this is the average flow velocity and that the flow will be faster in the middle of decomposition stage 118 and much slower near the inner wall of wide cross-section tube 144. A person skilled in the art will be able to determine the deceleration for any particular case from these general relationships and obtain more precise results by applying a standard fluid modeling software package also known in the art.

FIG. 1D illustrates still other important aspects of decomposition stage 118 of multi-stage reactor 100 tuned in the manner described above. More specifically, FIG. 1D is a perspective diagram illustrating the inside of decomposition stage 118 and outlet 116 of narrow cross-section tube 114 at end of heating stage 112 in more detail. The transition between heating stage 112 and decomposition stage 118 is again demarcated by dashed line C, as in FIGS. 1B-C.

In FIG. 1D molten material 158 in decomposition stage 118 is seen accumulated on the bottom of inner surface 145 of wide cross-section tube 144. As noted above, molten material 158 can be a molten metal or a molten salt in which carbon exhibits low levels of solubility. In fact, suitable molten material 158 can be chosen from among molten metals such as Fe, Co, Ni, Sn, Bi, Al, In, Ga, Cu, Pb, Zn, Mg, Sb, Si, Pd, Pt, Rh, or metal alloys such as Ni—Ga, Cu—Ga, Fe—Ga, Cu—Sn, Ni—Sn, Ni—Bi, Fe—Bi, Ni—Sn, Ni—Pb and the like. Further, molten material 158 can be selected from among salts such as NaCl, NaBr, KCl, KBr, LiCl, LiBr, CaCl₂, MgCl₂, CaBr₂, MgBr₂, ZnCl₂. Molten material 158 can be alloys or mixtures of any of these materials or any material with melting points below 2,000° C., or especially with melting points ranging between 0° C. to 2,000° C., and with vaporization points above 500° C. to 2,000° C. Molten material 158 may preferentially be comprised of a “host” or “carrier” material with a low melting temperature including but not limited to indium, zinc, aluminum, tin, and lead and a “catalyst” material that catalyzes the decomposition of the hydrocarbon, including but not limited to carbon products or elements, alloys, oxides, and salts containing metals such as Co, Ni, Fe, Cr, Mo, and noble metals as described in U.S. Pat. No. 10,851,307 B2 to Desai et al. and US Patent Application No. US 2020/0002165 A1 to Desai et al. Additionally, molten material 158 may contain seeding carbon materials such as carbon black, activated carbon, activated charcoal, C60, C70, carbon nanotubes, graphite flakes, and other carbon materials to seed nucleation and growth of carbon from the hydrocarbon decomposition onto the carbon seed material.

Due to rotation of tube 144, as indicated by arrow D, molten material 158 slides over the inner surface 145 of tube 144 in reaction stage 118 as indicated by arrow S. In the present embodiment rotation of tube 144 is maintained at a low rate that is contained in a second regime. The rotation rate can be expressed in terms of angular velocity ω is obtained from the following force balance equation:

F=mg=mrω²

In this equation m is the mass of molten material 158 and g is the gravitational constant. Angular velocity ω is obtained by expressing rotation rate D in rotations per second. Radius r is measured from the center of tube 144 to inner surface 145, as indicated in FIG. 1D. To avoid explicit reference to mass (which cancels out), it is also possible to obtain the required angular velocity ω from the dimensionless Froude number (Fᵣ) given by:

$${F}_{r} = ω \sqrt{\frac{r}{g}}$$

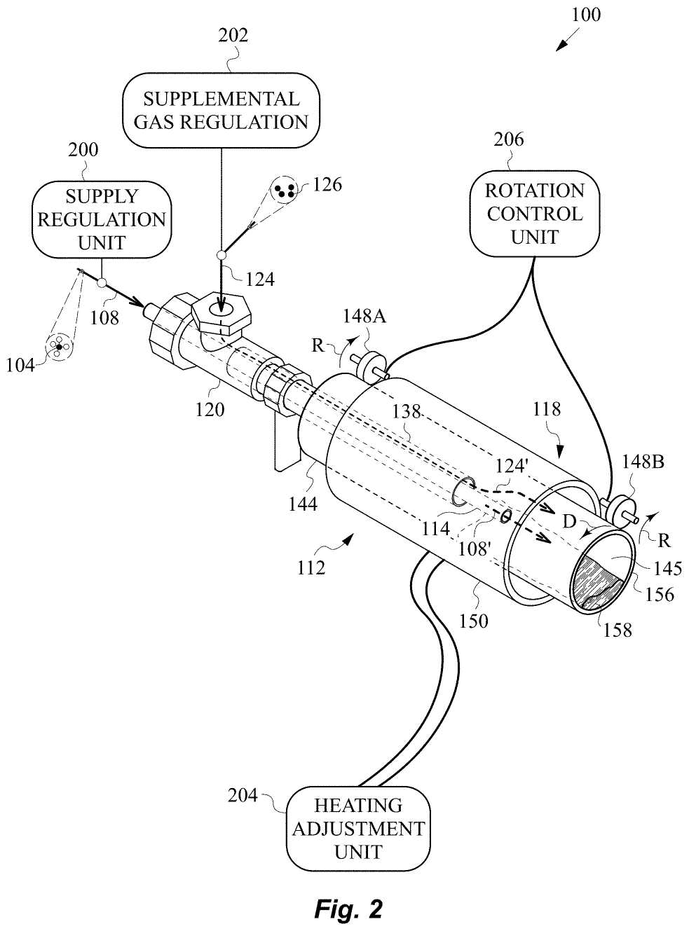

From these equations one obtains appropriate angular velocity ω for tube 144 in reactor 100. There are two main regimes the rotation rate of tube 144, in the low rate regime also called second regime, the Froude number is below 1 such that molten material 158 largely remains along the bottom of tube 144 as the centrifugal force experienced by the molten material 158 is not sufficient to overcome gravity. In a high rate regime also called first regime, the Froude number is greater than or equal to 1 such that the centrifugal force on molten material 158 overcomes gravity, enabling molten material 158 to coat inner surface 145 of tube 144. The Froude number needs to be >>1 in order to form an even coating of molten material 158 on inner surface 145, as illustrated in FIG. 4. In the high rate regime where Fᵣ>1, molten material 158 minimizes or prevents the build-up of carbon on inner surface 145, effectively minimizing clogging of reactor 100. The carbon that builds up on molten material 158 is simply carried out of reactor 100 with the outflowing gases through outlet 156.

In the low rate regime where Fᵣ<1, molten material 158 only lines the bottom of tube 144. In moving over surface 145 molten material 158 effectively acts as a continuous mop that removes carbon 162 produced during thermochemical decomposition reaction of hydrocarbon feedstock 104. This also minimizes the build-up of carbon on inner surface 145, thus substantially minimizing the clogging of reactor 100.

As a visual aid, the thermochemical decomposition reaction occurring in reaction stage 118 itself is indicated in FIG. 1D schematically by reference 174. Note that the decomposition reaction that produces carbon 162 is also accompanied by the production of hydrogen 164. Now, carbon 162 will build-up on the inner wall or surface 145 of tube 144 as reaction 174 progresses. Advantageously, however, as tube 144 rotates, liquid metal or salt 158 cleans up the deposits of carbon 162. These deposits are then expelled from reaction stage 118 as chunks or flakes carried out by the outflowing gases.

As seen by turning back to FIG. 1A, both hydrogen 164 and carbon 162 are captured in separation stage 160. Separation stage 160 collects carbon 162 in vessel 166 by relying on gravity separation. This part of separation can be implemented with a baghouse filter known in the art. Meanwhile, any remaining hydrocarbon feedstock 104 exiting decomposition stage 118 is separated from hydrogen 164 with a suitable membrane and H₂ purification of hydrogen 164 (H₂), as also known in the art.

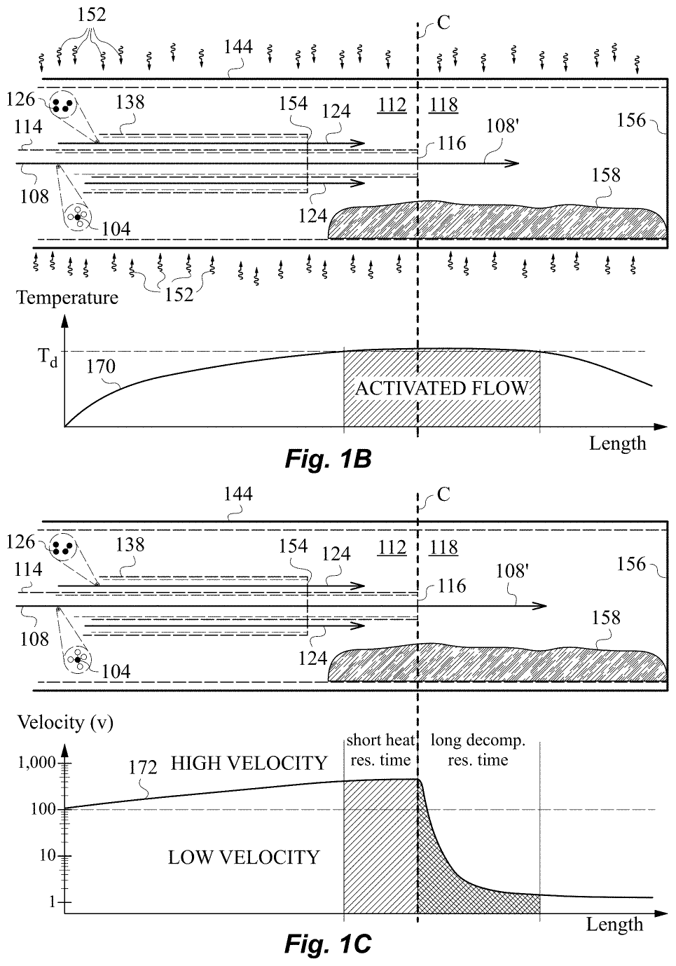

FIG. 2 illustrates in a three-dimensional diagram the main steps involved in operating multi-stage decomposition reactor 100 of FIG. 1A in accordance with several aspects of the invention. Specifically, it is important to operate reactor 100 to ensure the tuning that provides for minimal coking in heating stage 112 and substantial progression of thermochemical decomposition in decomposition stage 118 accompanied by cleaning action of molten material 158.

During operation, supply flow 108 is regulated by a supply regulation unit 200 to ensure that hydrocarbon feedstock 104 is admitted into reactor 100 at a sufficient velocity. Although heating that occurs in heating stage 112 will act to accelerate flow 108, as seen in velocity profile 172 of FIG. 1C, initial flow rate should still be set sufficiently high to ensure that activated flow 108′ experiences a short heating residence time tₕᵣ inside narrow cross-section tube 114 of heating stage 112. As mentioned above, this is part of the tuning that ensures that only very limited pyrolysis or thermochemical decomposition of hydrocarbon feedstock 104 takes place inside tube 114. Again, that is by virtue of keeping heating residence time tₕᵣ of active flow 108′ inside heating stage 112 significantly shorter than average decomposition onset time t_{dec} of hydrocarbon feedstock 104 at decomposition temperature T_{d} reached inside tube 114. Preferably, supply flow 108 is continuously adjustable by supply regulation unit 200 so as to correspondingly shift velocity profile 172 (see FIG. 1C) and ensure that the short heating residence time tₕᵣ condition holds; thus also preventing coking on the inner wall of narrow cross-section tube 114.

Reactor 100 has a supplemental gas regulation unit 202 that controls flow 124 of supplemental gas 126. It is important that flow 124 be sufficient to aid in the function of the supplementary gas 126 when it enters heating stage 118 to create a barrier layer 124′. As mentioned above, one of the functions of barrier layer 124′ of hot and inert supplemental gas 126 is to prevent contact between the thermally decomposing hydrocarbon feedstock 104 and wide cross-section tube 144. Inert in this context refers to any gas that does not react with tube wall 145 and preferably does not react with hydrocarbon feedstock 104 to be decomposed.

In fact, as an alternative to molten material 158 within rotating tube 144, outlet 116 of heating stage 112 can terminate inside decomposition stage 118. Here, the moving wall of supplementary gas 126 can serve as a substitute to molten material 158 within rotating tube 144 by forming a moving gas wall along decomposition stage 118. It is noted that this approach is similar to reactors described in U.S. Pat. No. 4,059,416 to Matovich, U.S. Pat. No. 4,643,890 A to Schramm, and U.S. Pat. No. 6,872,378 to Weimer et al.

In the present embodiment of the invention, barrier layer 124′ is constituted by flow 124 of supplemental gas 126, e.g., nitrogen (N₂), argon (Ar) or hydrogen (H₂) as it exits barrier tube 138. Barrier layer 124′ forms along inner wall 145 of tube 144 within decomposition stage 118. Supplemental gas regulation unit 202 that controls flow 124 of supplemental gas 126 ensures that its flow rate and volume are sufficient to form barrier layer 124′ and that it is effective.

In embodiments using barrier layer 124′ inner wall 145 of wide cross-section tube 144 into which activated flow 108′ of hydrocarbon feedstock 104 flows is porous or perforated. Porous wall 145 allows supplemental gas 126 to flow through it. By thus preventing contact between the thermally decomposing hydrocarbon feedstock 104 and tube 144, carbon deposition is substantially minimized and clogging of decomposition stage 118 is avoided.

In prior work, by JM Huber Corp found in U.S. Pat. No. 4,643,890, a perforated gas wall is described as preferable to a micro-porous gas wall, as is described in U.S. Pat. No. 4,059,416, in order to get a higher radial velocity gas flow into the decomposition zone. In this prior work, unlike in the present embodiment, the incoming gas flow needed to serve the dual purpose of preventing deposition of carbon on the reactor wall and providing heat to the hydrocarbon feedstock.

In the present invention, since reactor 100 includes heater 150 and heating stage 112 in which hydrocarbon feedstock 104 is brought to or above decomposition temperature T_{d}, the primary function of supplemental gas 126 flowing through wall 145 of tube 144 is to minimize deposition on wall 145 rather than adding heat to hydrocarbon stock 104. This enables the use of micro-porous wall 145 at a significantly lower level of consumption of supplemental gas 126. This, in turn, improves reactor economics in designs of the present invention.

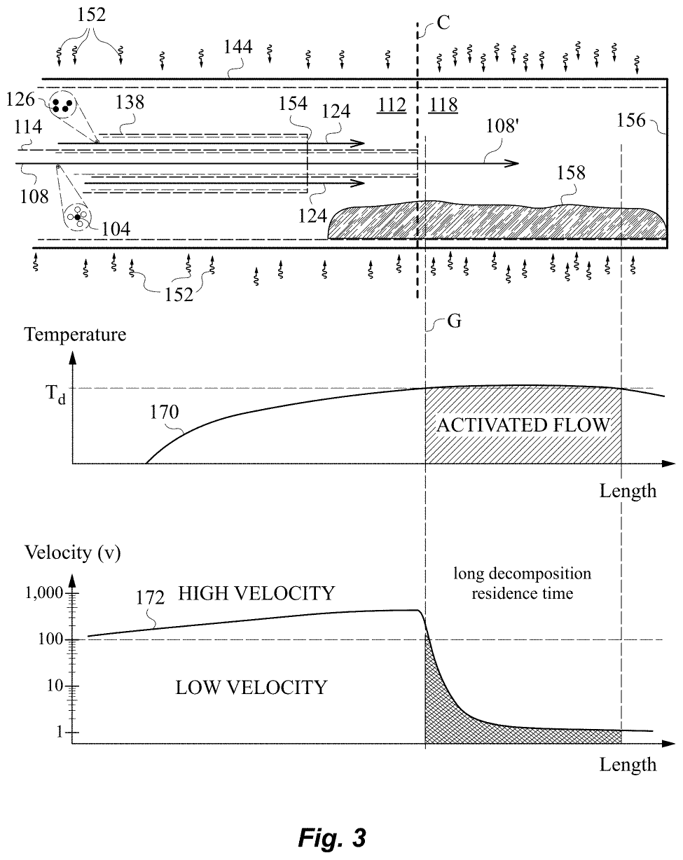

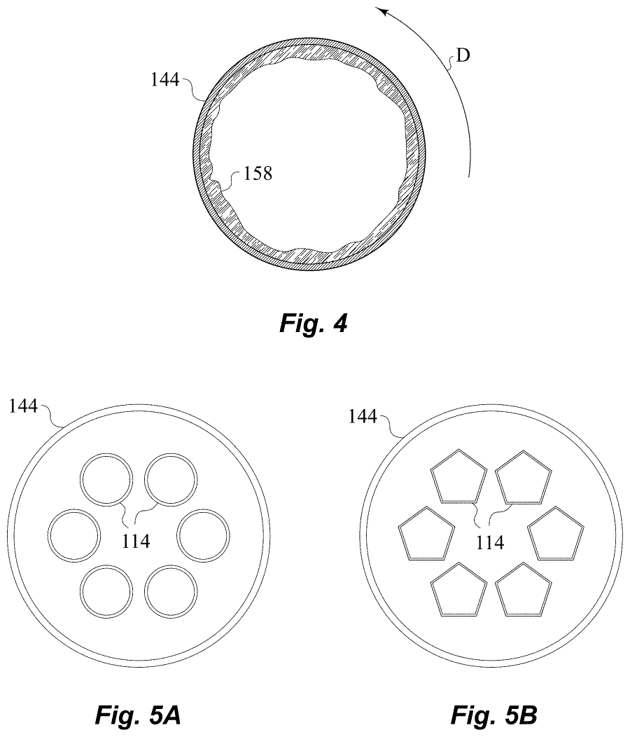

In practice, heater 150 of reactor 100 would have a plurality of narrow tubes flowing into decomposition stage 118, as illustrated in the cross-sectional view of FIG. 5A. FIG. 5B demonstrates that the narrow cross-section tubes in the heating stage can alternatively have a polygonal shape rather than solely a circular cross-sectional shape. Furthermore, heating stage 112 could resemble a shell and tube heat exchanger, such as shown in FIG. 6. In the shell and tube heat exchanger configuration shown in FIG. 6, multiple tubes 114 are arranged parallel inside of an outer shell, inside of which a gas such as natural gas or hydrogen is combusted to generate heat that transfers to the tubes 114 and then to the hydrocarbon feedstock flowing inside of tubes 114. In this embodiment, baffles may be used to improve the heat transfer between the combusted gas and the tubes, and inlets and outlets for the combustion gas reactants and products will be separate from the tube inlets and outlets of the shell and tube heat exchanger.

It is preferable for heating stage 112 to be heated by electrical heater 150 via resistive or inductive heating to minimize carbon dioxide emissions from burning hydrocarbon fuels. However, in cases where the price of electricity is high and/or not continuous, hydrogen or a hydrocarbon fuel can be combusted in the presence of an oxidizer, such as air or pure oxygen, to generate heat to heat up hydrocarbon feedstock 104 flowing through heater 150 to or above decomposition temperature T_{d}. The preheating and/or superheating steps can also be performed with heater 150 that uses a plasma (thermal or non-thermal), microwave energy or other energy input suitable to achieve decomposition of hydrocarbon feedstock 104.

A suitable heating adjustment unit 204 (depending on the type of heater 150) is connected to heater 150 to control the amount of energy or heat delivered in heating stage 112 and decomposition stage 118. Again, the amount of heat delivered by heater 150 is adjusted by unit 204 to keep reactor 100 tuned as taught above. In the example shown, heater 150 is electric and hence unit 204 controls its output via the supply of electrical current. Preferably, heater 150 allows unit 204 to adjust the amount of energy or heat delivered at different stages along the length of reactor 100. In other words, preferably different amounts of heat can be set for heating stage 112 and decomposition stage 118. Such flexibility can ensure better control over the aforementioned tuning of reactor 100.

Further, reactor 100 has a rotation control unit 206 that controls the speed or rate of rotation R of rotation drives 148A, 148B. In the present embodiment the cross-section of wide cross-section tube 144 is constant and thus both drives are locked to rotate at the same rotation rate R. In embodiments where cross-section of tube 144 varies along the length of reactor 100 the rates of rotation will differ. In any case, rates of rotation R are such as to produce rotation D of tube 144 in the first range (low rate regime where Fᵣ<1) or in the second range (high rate regime where Fᵣ>1), as discussed above.

All supply and control units 200, 202, 204, 206 can be operated in concert by a suitable coordinating unit (not shown). In embodiments where units 200, 202, 204, 206 and their actions are coordinated by a central or coordinating unit feedback can be used to further improve operation and ensure efficient tuning of reactor 100 in accordance with the invention.

In some embodiments multi-stage decomposition reactor 100 also has a pre-heating stage. The pre-heating stage is not shown in FIG. 1A or FIG. 2. When present, pre-heating stage is placed before heating stage 112 and is designed for pre-heating supply flow 108 of hydrocarbon feedstock 104 to yield a substantially uniformly pre-heated flow. The pre-heating temperature may be in the range of a few hundred degrees, e.g., up to 400° C. Thus, the pre-heating temperature remains below decomposition temperature T_{d}, which is typically above 1,000° C., as previously noted.

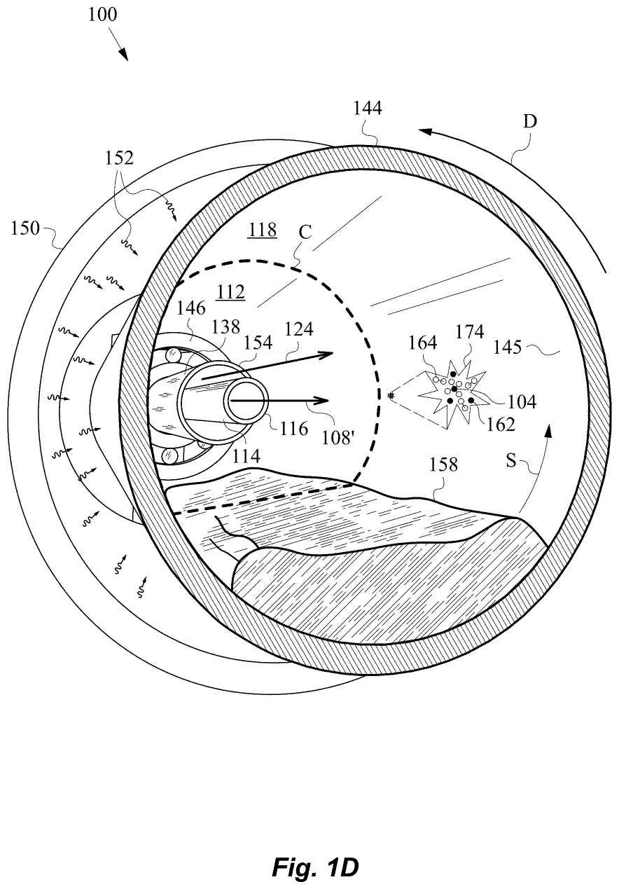

FIG. 3 is a cross-sectional side view diagram of the heating and decomposition stages of a multi-stage decomposition reactor exhibiting a different tuning along with a velocity profile and a temperature profile. For clarity, same numerals are used to refer to corresponding elements of this reactor as those deployed in FIGS. 1-2.

In the embodiment of FIG. 3 the reactor is not tuned in a manner where heating stage 112 brings up the temperature of hydrocarbon feedstock 104 up to decomposition temperature T_{d} within narrow cross-section tube 114. Instead, heating stage 112 is designed for heating supply flow 108 to yield a heated flow of hydrocarbon feedstock 104 at below the decomposition temperature T_{d}, or below 1,000° C. (for non-catalyzed cases). The amount of heat energy 152 delivered to hydrocarbon feedstock 104 in heating stage 112 is kept at a level that is insufficient to heat it to decomposition temperature T_{d}. Therefore, supply flow 108 of hydrocarbon feedstock 104 does not form activated flow 108′ while inside narrow cross-section tube 114, as it did in the prior embodiments.

In these embodiments it is decomposition stage 118 that heats supply flow 108 received from the heating stage 112 to decomposition temperature T_{d} to yield activated flow 108 of hydrocarbon feedstock 104. To accomplish that, the amount of heat energy 152 delivered to hydrocarbon feedstock 104 in decomposition stage 118 is increased. Thus, supply flow 108 turns to activated flow shortly after exiting tube 114. The point along the length of decomposition stage 118 at which supply flow 108 becomes activated and turns to activated flow 108′ is identified by dashed line G. Dashed line G also extends down to temperature profile 170 where it demarcates directly on the plot of temperature profile 170 the transition to activated flow 108′ (also expressly designated by hatching).

Dashed line G extends further down to velocity profile 172 where the portion of velocity profile 172 during which active flow 108′ is present is designated by cross-hatching. Just as in the prior embodiments, the deceleration experienced by active flow 108′ in decomposition stage 118 ensures a long decomposition residence time. Thus, substantial progress of the thermochemical decomposition of hydrocarbon feedstock 104 is achieved in decomposition stage 118.

In the context of the present invention, decomposition temperature T_{d} is either the non-catalyzed or catalyzed decomposition temperature of hydrocarbon feedstock 104. If there is no catalyst present, the decomposition temperature T_{d} is taken as the non-catalyzed decomposition temperature of hydrocarbon feedstock 104. This is about 1,000° C. for methane or natural gas. If there is a catalyst present, either in the molten material 158, in narrow cross-section tube 114 of heating stage 112, in the walls of tube 144 of decomposition stage 118, or as a seed material in hydrogen feedstock 104 itself, then decomposition temperature T_{d} is taken as the catalyzed decomposition temperature of hydrocarbon feedstock 104. This is about 400° C. for methane or natural gas. Hydrocarbon feedstock 104 decomposition temperature T_{d} is thus dependent on hydrocarbon feedstock 104 that is used as well as the catalytic or non-catalytic materials used in reactor 100. Catalytic materials include Group VIb and VIII elements of the periodic table such as iron, nickel, cobalt, noble metals, chromium, molybdenum, alloys of these metals and even salts and oxides containing these metals and still other suitable catalytic materials. A person skilled in the art will recognize that the tuning of reactor 100 is to be adjusted depending on decomposition temperature T_{d}.

Although the above embodiments focus on various electrical elements for performing the required heating, i.e., by using inductive, resistive or microwave heating means, combustion can also be used in the present invention. FIG. 6 is a three-dimensional diagram illustrating a shell and tube heat exchanger 300 that can be deployed in an alternative embodiment of the multi-stage decomposition reactor as a heating stage according to the invention. Alternatively, tube heat exchanger 300 can be integrated within a multi-stage reactor as described above, e.g., in reference to FIG. 1A.

The view afforded by FIG. 6 shows the important internal parts of heat exchanger 300. Heat exchanger 300 has a cylindrical main tube 302 with an inlet 304 and an outlet 306. A number of circular and narrow cross-section tubes 308 are arranged to pass through the center portion of main tube 302. In the present case four narrow cross-section tubes 308A-D are shown, but the number of these tubes could range from just one to many more than four.

Each one of tubes 308A-D is designed to carry a supply flow 310 of a hydrocarbon feedstock 312 through heat exchanger 300. Only supply flow 310 of hydrocarbon feedstock 312 through tube 308A is expressly indicated for reasons of clarity. Once again, hydrocarbon feedstock 312 is methane (CH₄) in this example embodiment.

The interior of main tube 302 is separated into zones with the aid of baffles 314. Only four baffles 314 are shown. A person skilled in the art will realize that more of fewer baffles 314 can be used in order to enable practice of the invention in accordance with the principles explained above.

During operation, inlet 304 admits an input combustion burner flow 316 of hot combustion gas that heats the supply flow 310 of hydrocarbon feedstock 312 passing through tubes 308A-D. Outlet 306 releases cooled down combustion gas 318 from heat exchanger 300.

The temperature to which flow 316 heats flow 310 is set as before. Namely, input flow 316 is computed such that supply flow 310 reaches the decomposition temperature and turns into activated flow 310′. At the same time, the velocity of activated flow 310′ in tubes 308A-D is high enough to such that the heating residence time of activated flow 310 in the heating stage is significantly shorter than an average decomposition onset time of feedstock 312.

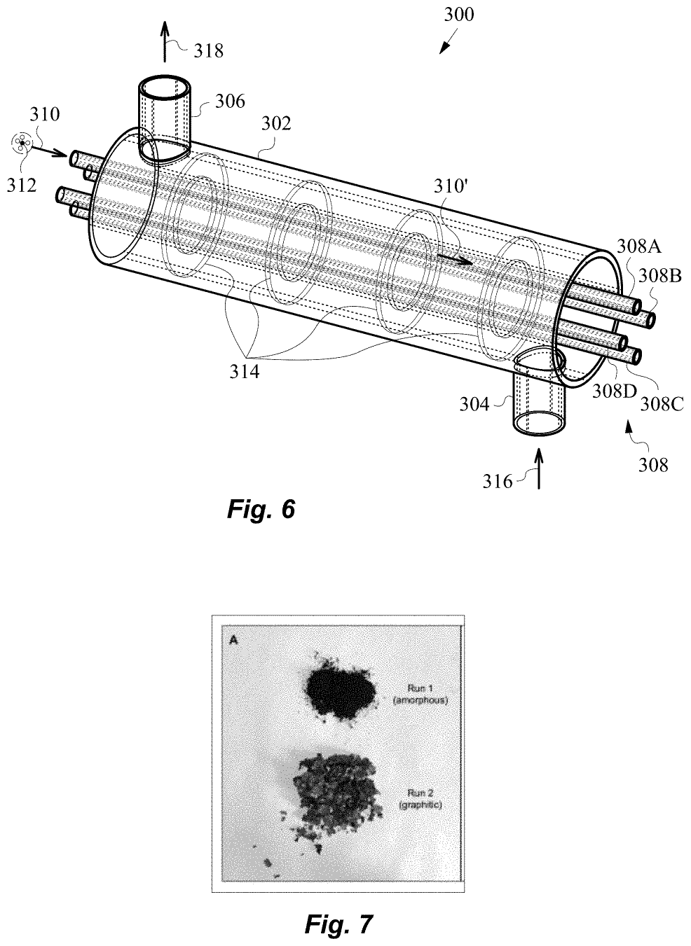

FIG. 7 is a photograph of a more amorphous and more graphitic carbon black formed in two different runs of a multi-stage decomposition reactor according to the invention by varying the decomposition step. It will be appreciated that differing thermal decomposition parameters of the reactor allow the user to tune the type of carbon black that is produced. A person skilled in the art will further appreciate that in any specific case the tuning of temperature, flow velocity of activated flow and residence time will permit the operator to fine-tune the type of carbon black product that is desired.

It will be evident to a person skilled in the art that the present invention admits of various other embodiments. Therefore, its scope should be judged by the claims and their legal equivalents.

1. A multi-stage decomposition reactor for a thermochemical decomposition of a hydrocarbon feedstock, said multi-stage decomposition reactor comprising:
a) a means for delivering a supply flow of said hydrocarbon feedstock into said multi-stage decomposition reactor;
b) a heating stage having a cavity for heating said supply flow to a decomposition temperature to yield an activated flow of said hydrocarbon feedstock, wherein a length of said heating stage and a velocity of said activated flow in said heating stage are tuned such that a heating residence time of said activated flow in said heating stage is significantly shorter than an average decomposition onset time of said hydrocarbon feedstock at said decomposition temperature; and
c) a decomposition stage for supporting a decomposition residence time of said activated flow longer than said average decomposition onset time to achieve substantial progression of said thermochemical decomposition.

2. The multi-stage decomposition reactor of claim 1, wherein said decomposition stage comprises:
a) a wide cross-section tube containing a molten material;
b) a means for rotating said wide cross-section tube at a predetermined rotation speed to minimize carbon build-up and to clean said decomposition stage.

3. The multi-stage decomposition reactor of claim 2, wherein said predetermined rotation speed is in a first high speed regime such that said molten material coats at least a substantial portion of an inner wall of said wide cross-section tube.

4. The multi-stage decomposition reactor of claim 2, wherein said predetermined rotation speed is in a second low speed regime such that said molten material largely accumulates at the bottom of an inner wall of said wide cross-section tube.

5. The multi-stage decomposition reactor of claim 1, wherein said decomposition stage comprises a wide-cross section tube, said wide-cross section tube having a porous or perforated inner wall permitting a hot and inert gas flow therethrough, thereby creating a barrier layer for preventing contact between said thermally decomposing hydrocarbon feedstock and said wide cross-section tube.

6. The multi-stage decomposition reactor of claim 1, further comprising a pre-heating stage before said heating stage, said pre-heating stage pre-heating said supply flow of hydrocarbon feedstock to yield a substantially uniformly pre-heated flow of said hydrocarbon feedstock at a temperature below said decomposition temperature.

7. The multi-stage decomposition reactor of claim 1, wherein said hydrocarbon feedstock substantially comprises methane or natural gas and said carbon product comprises solid carbon.

8. The multi-stage decomposition reactor of claim 1, wherein said cavity of said heating stage comprises a narrow cross-section tube for maintaining said velocity of said activated flow at above 10 meters/second.

9. The multi-stage decomposition reactor of claim 8, wherein said narrow cross-section tube has an electrical means for performing said heating, said electrical means being selected from among inductive heating means, resistive heating means and microwave heating means.

10. The multi-stage decomposition reactor of claim 8, wherein said narrow cross-section tube has a combustion heating means for performing said heating.

11. The multi-stage decomposition reactor of claim 1, further comprising a radiative heating means for transferring energy to said hydrocarbon feedstock in said decomposition stage.

12. The multi-stage decomposition reactor of claim 1, further comprising a microwave heating means for transferring energy to said hydrocarbon feedstock in said decomposition stage.

13. A stage-wise method for a thermochemical decomposition of a hydrocarbon feedstock, said method comprising:
a) delivering a supply flow of said hydrocarbon feedstock to a heating stage having a cavity;
b) heating said supply flow in said heating stage to a decomposition temperature to yield an activated flow of said hydrocarbon feedstock;
c) tuning a length of said heating stage and a velocity of said activated flow in said heating stage such that a heating residence time of said activated flow in said heating stage is significantly shorter than an average decomposition onset time of said hydrocarbon feedstock at said decomposition temperature; and
d) supporting said activated flow in a decomposition stage for a decomposition residence time longer than said average decomposition onset time of said hydrocarbon feedstock at said decomposition temperature.

14. The stage-wise method of claim 13, further comprising:
a) providing said decomposition stage with a wide cross-section tube containing a molten material;
b) rotating said wide cross-section tube at a predetermined rotation speed to minimize carbon build-up and to clean said decomposition stage.

15. The stage-wise method of claim 13, further comprising:
a) providing said decomposition stage with a wide cross-section tube having a porous or perforated wall;
b) providing a buffer flow of a hot and inert gas to create a barrier layer preventing contact between said hydrocarbon feedstock and said wide cross-section tube.

16. A decomposition reactor for a thermochemical decomposition of a hydrocarbon feedstock, said decomposition reactor comprising:
a) a decomposition stage for receiving a flow of said hydrocarbon feedstock, said decomposition stage having a wide cross-section tube containing a molten material;
b) a means for rotating said wide cross-section tube at a predetermined rotation speed to minimize carbon build-up and to clean said wide cross-section tube.

17. The decomposition reactor of claim 16, wherein said predetermined rotation speed is in a first high speed regime such that said molten material coats at least a substantial portion of an inner wall of said wide cross-section tube.

18. The decomposition reactor of claim 16, wherein said predetermined rotation speed is in a second low speed regime such that said molten material largely accumulates at the bottom of an inner wall of said wide cross-section tube.

19. The decomposition reactor of claim 16, wherein said molten material is selected from among molten metals and molten salts.

20. The decomposition reactor of claim 19, wherein said molten material includes at least one material that catalyzes said thermochemical decomposition of said hydrocarbon feedstock.

21. The decomposition reactor of claim 16, wherein energy for said thermal decomposition of said hydrocarbon feedstock is provided by a heating means selected from among inductive heating means, resistive heating means, thermal plasma, non-thermal plasma, microwave heating means or combustion heating means.

22. The decomposition reactor of claim 16, wherein said hydrocarbon feedstock is delivered to said wide cross-section tube in a temperature range from room temperature to substantially below a decomposition temperature of said hydrocarbon feedstock.

23. The decomposition reactor of claim 16, wherein said hydrocarbon feedstock is delivered to said wide cross-section tube in a temperature range from a decomposition temperature of said hydrocarbon feedstock to substantially above said decomposition temperature.

24. The decomposition reactor of claim 16, wherein said hydrocarbon feedstock is a gaseous hydrocarbon.

25. The decomposition reactor of claim 16, wherein said hydrocarbon feedstock comprises substantially methane or natural gas and a carbon product obtained comprises substantially solid carbon.

26. The decomposition reactor of claim 16, wherein said thermochemical reaction is pyrolysis.

27. The decomposition reactor of claim 26, wherein said decomposition reaction is maintained in an oxygen-poor environment.

28. The decomposition reactor of claim 16, wherein said molten material has a volume that is less than 50% of the internal volume of said decomposition reactor.
